(19) United States
(12) Patent Application Publication
(10) Pub. No.: US 2026/0267732 A1
(43) Pub. Date: Sep. 10, 2026

(54) PHYSICAL COMPUTING SYSTEM WITH NON-RECONSTRUCTIVE AND HIERARCHICAL FIELD-STATE DECODING

(71) Applicant: Anil P Rami, MOUNDSVILLE, WV (US)

(72) Inventor: Anil P Rami, MOUNDSVILLE, WV (US)

(21) Appl. No.: 19/660,178

(22) Filed: Apr. 27, 2026

Related U.S. Application Data
(63) Continuation-in-part of application No. 19/452,222, filed on Jan. 16, 2026.

(51) Int. Cl. G06F 11/07

(52) U.S. Cl. CPC G06F 11/0793

(57) ABSTRACT

A physical computing system is disclosed comprising a continuous physical medium in which computation occurs through dynamic evolution of distributed field states. A decoder is configured to extract output information directly from the resulting field states without requiring reconstruction of the full system state or reliance on predefined output mappings. The decoder operates in a hierarchical manner, wherein a reduced-dimensional representation of the field state is extracted under normal operation, and partial or full-state reconstruction is selectively performed when required. The decoder is non-participatory in the evolution of the physical medium and does not impose computational structure. This enables efficient extraction of computationally relevant information from distributed physical systems while preserving the intrinsic dynamics of the medium.

### CROSS-REFERENCE TO RELATED APPLICATIONS

This application is a continuation-in-part of U.S. patent application Ser. No. 19/452,222, titled “FIELD-BASED LIGHT COMPUTING WITHOUT STORED TOPOLOGY AND METHODS OF DECODING RESULTING FIELD STATES,” filed Jan. 15, 2026, the entirety of which is incorporated herein by reference. This application is further related to U.S. Patent Application Ser. No. 19/455,843, titled “NONLINEAR PHYSICAL COMPUTING ARCHITECTURE WITH SUBSTRATE-NATIVE MEMORY AND HISTORY-DEPENDENT COMPUTATION”; Ser. No. 19/547,362, titled “NONLINEAR PHYSICAL COMPUTING ARCHITECTURE WITH RESET-VERIFIED CONVERGENCE ACCELERATION AND KINETIC ENERGY MANAGEMENT”; Ser. No. 19/549,231, titled “NONLINEAR PHYSICAL COMPUTING ARCHITECTURE WITH DOMAIN-WIDE PARAMETER-FIELD RESHAPING, ATTRACTOR-LANDSCAPE MODIFICATION, GRADIENT PERSISTENCE MODULATION, AND MULTI-DOMAIN ORCHESTRATION”; and Ser. No. 19/640,336, titled “NONLINEAR PHYSICAL COMPUTING ARCHITECTURE WITH DYNAMIC INTRA-SUBSTRATE DOMAIN SEGMENTATION AND CONTROLLED DOMAIN EVOLUTION”; the entireties of which are incorporated herein by reference.

### FIELD OF THE INVENTION

The present invention relates to physical computing systems implemented in continuous media, and more specifically to methods and systems for extracting computational output from distributed field states without predefined output topology or full-state reconstruction.

### BACKGROUND OF THE INVENTION

Existing computing systems rely on predefined output structures, explicit variable mappings, or reconstruction of internal state representations to determine computational results. In analog, digital, neuromorphic, and photonic systems, output is typically defined by fixed ports, readout nodes, or reconstructed representations derived from the system state.

Such approaches introduce structural constraints, require explicit interpretation pipelines, and often necessitate reconstruction of high-dimensional internal states to determine output values.

Prior systems do not provide a decoder architecture capable of extracting meaningful computational output from distributed physical systems without reliance on predefined mappings or full-state reconstruction.

Prior systems do not provide hierarchical decoding wherein a reduced-dimensional representation of the field state is extracted under normal operation and partial or full-state reconstruction is selectively performed when required.

Prior systems do not provide a non-participatory decoder that extracts output from emergent field state properties without imposing structure on or participating in the evolution of the physical medium.

There remains a need for a decoding architecture capable of extracting meaningful computational output from distributed physical systems without reliance on predefined mappings or full-state reconstruction, while preserving the intrinsic dynamics of the medium.

### SUMMARY OF THE INVENTION

The invention provides a physical computing system comprising a continuous physical medium supporting dynamic evolution of distributed field states and a decoder configured to determine output by direct observation of said field states. The decoder operates without predefined output mapping and without requiring reconstruction of the full system state.

In certain embodiments, the decoder extracts a reduced-dimensional representation of the field state sufficient to determine computational output. The reduced-dimensional representation is derived from spatial, spectral, temporal, or statistical characteristics of the field.

In certain embodiments, the decoder selectively performs partial or full-state reconstruction when required for validation, calibration, or extended analysis.

In certain embodiments, the decoder is non-participatory in the evolution of the physical medium and does not materially influence the underlying dynamics.

In certain embodiments, output is determined from emergent properties of the field state without reliance on fixed output ports, predefined spatial nodes, or predetermined variable assignments.

### DETAILED DESCRIPTION

### Distributed Field-State Computation

The system comprises a physical medium in which computation occurs through evolution of distributed field states. The field may be optical, electrical, magnetic, mechanical, thermal, or multi-physical. The resulting field state is spatially and temporally distributed and does not correspond to predefined output locations or discrete variables.

### Non-Reconstructive Decoding

The decoder determines output directly from the field state without reconstructing the full internal state of the medium. In certain embodiments the decoder extracts spatial features, spectral features, temporal features, statistical aggregates, or invariant structures. Such features constitute a reduced-dimensional representation sufficient to determine computational output.

### Reduced-Dimensional Representation

The decoder operates by collapsing the high-dimensional field state into a lower-dimensional signal space. This collapse does not require explicit reconstruction of intermediate states and does not rely on predefined variable mappings. The collapse may be lossy but preserves computationally relevant structure. The reduced representation may include intensity distributions, phase relationships, correlation structures, frequency-domain components, or convergence characteristics of the field state.

### Hierarchical Decoding

The decoder operates in multiple modes. In a primary mode, the decoder performs reduced-dimensional extraction with minimal computational overhead sufficient for normal operation. In a secondary mode, the decoder performs partial reconstruction used for ambiguity resolution or verification. In a full-state mode, the decoder performs reconstruction of full or near-full field state used for calibration, diagnostics, or analysis.

### Non-Participatory Measurement

The decoder is configured such that it does not impose structure on the computational medium, does not define computational pathways, and does not participate in state evolution. Measurement is performed in a manner that does not materially influence the dynamics of the physical medium.

### Absence of Predefined Output Mapping

Output is not defined by fixed output ports, predefined spatial nodes, or predetermined variable assignments. Instead, output is determined from emergent properties of the field state as a consequence of the physical evolution of the medium.

### Relationship to Persistent-State Compute Architecture

In certain embodiments, the physical medium is a persistent-state compute substrate in which prior excitation history modifies the governing parameter field and thereby alters future convergence behavior. In such embodiments, the reduced-dimensional representation extracted by the decoder may include convergence time, state-space trajectory length, or energy dissipation characteristics of the field state, enabling the decoder to extract computationally relevant output without requiring reconstruction of the full convergence history.

### Structural Exclusions

The disclosed decoder architecture does not rely upon predefined output ports, fixed spatial readout nodes, predetermined variable-to-output mappings, full-state reconstruction as a prerequisite for output determination, or participation in the evolution of the physical medium.

1. A physical computing system comprising: a continuous physical medium configured to support dynamic evolution of distributed field states; and a decoder configured to determine output by direct observation of resulting field states, wherein said decoder determines output from emergent properties of said field states without reliance on predefined output mappings, without reliance on fixed output ports, and without reconstructing the full internal state of said medium, and wherein said decoder does not participate in or impose structure upon the evolution of said physical medium.

2. The system of claim 1, wherein said decoder extracts a reduced-dimensional representation of said field state comprising at least one of spatial, spectral, temporal, or statistical characteristics of said field state.

3. The system of claim 1, wherein said decoder selectively performs partial reconstruction of said field state for at least one of ambiguity resolution or verification.

4. The system of claim 1, wherein said decoder selectively performs full-state reconstruction of said field state for at least one of calibration, diagnostics, or analysis.

5. The system of claim 1, wherein said decoder operates in a hierarchical mode comprising a primary reduced-dimensional extraction mode and at least one higher-resolution reconstruction mode.

6. The system of claim 2, wherein said reduced-dimensional representation preserves convergence characteristics of said field state.

7. The system of claim 2, wherein said reduced-dimensional representation is derived without predefined variable mapping.

8. The system of claim 2, wherein said reduced-dimensional representation comprises at least one of intensity distributions, phase relationships, correlation structures, frequency-domain components, or convergence time of said field state.

9. The system of claim 1, wherein said physical medium supports at least one of optical, electrical, magnetic, mechanical, or thermal field states.

10. The system of claim 1, wherein said physical medium is a persistent-state compute substrate in which prior excitation history modifies a governing parameter field and thereby alters future convergence behavior of said medium.

11. The system of claim 10, wherein said reduced-dimensional representation extracted by said decoder comprises at least one of convergence time, state-space trajectory length, or energy dissipation characteristics of said field state.

12. The system of claim 1, wherein said decoder measurement does not materially influence the dynamics of said physical medium.

13. A method of extracting computational output from a physical computing system comprising: providing a continuous physical medium supporting dynamic evolution of distributed field states; allowing said medium to evolve toward a stable field state through physical dynamics; and determining output by direct observation of emergent properties of said resulting field state without reconstructing the full internal state of said medium and without reliance on predefined output mappings or fixed output ports.

14. The method of claim 13, further comprising extracting a reduced-dimensional representation of said field state comprising spatial, spectral, temporal, or statistical characteristics of said field state.

15. The method of claim 13, further comprising selectively performing partial or full-state reconstruction when required for validation, calibration, or extended analysis.
